(19) United States
(12) Patent Application Publication
(10) Pub. No.: US 2015/0186933 A1
(43) Pub. Date: Jul. 2, 2015

(54) Methods and Apparatus for Advertising Using a Frequency of Spoken Word Database

(71) Applicant: Google Technology Holdings LLC, Mountain View, CA (US)

(72) Inventors: Michael J. Lombardi, Lake Zurich, IL (US); Amber M. Pierce, Evanston, IL (US)

(21) Appl. No.: 14/191,719

(22) Filed: Feb. 27, 2014

Related U.S. Application Data
(60) Provisional application No. 61/921,877, filed on Dec. 30, 2013.

(51) Int. Cl. G06Q 30/02; G10L 15/08

(52) U.S. Cl. CPC G06Q 30/0251; G10L 15/08; G06Q 30/0273

(57) ABSTRACT

An electronic device performs a method for advertising using a frequency of spoken word database. The method includes sending a plurality of observation phrases to a plurality of mobile devices and receiving, from a subset of the plurality of mobile devices for each observation phrase in a subset of the plurality of observation phrases, at least one utterance statistic that indicates how often the utterance of observation phrase was detected by the subset of the plurality of mobile devices over a time period. The method further includes building a frequency of spoken word database including the subset of the plurality of observation phrases each having associated therewith a set frequency of utterance values derived from the at least one utterance statistic received for that observation phrase. The frequency of spoken word database is used to determine at least one advertisement and linked observation phrase to send to a mobile device.

### RELATED APPLICATIONS

This application is a non-provisional application of co-pending and commonly assigned U.S. Provisional Patent Application No. 61/921,877, filed on Dec. 30, 2013, from which benefits under 35 USC §119(e) are hereby claimed and the contents of which are hereby incorporated by reference herein.

### FIELD OF THE DISCLOSURE

The present disclosure relates to advertising, and more particularly to advertising using a frequency of spoken word database.

### BACKGROUND

As mobile devices are being used for more varied functionality, they have become a medium for advertising. To make the most effective use of their advertising dollars, advertisers typically desire to direct their advertisements to consumers that are likely to be receptive to those advertisements. To this end, current advertising mechanisms that use a mobile device to deliver the advertisements respond to a user's query and very quickly determine the most relevant advertisement(s) for that user. Such advertisement mechanisms are, however, limited in their ability to push relevant advertisements to users irrespective of a user query.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 is a schematic diagram illustrating an example environment within which may be implemented methods and apparatus for advertising using a frequency of spoken word database in accordance with the present teachings.

FIG. 2 is a block diagram illustrating example internal components of a server configured in accordance with the present teachings.

FIG. 3 is a block diagram illustrating example internal components of a mobile device configured in accordance with the present teachings.

FIG. 4 is one example of a message sequence chart illustrating communications that occur between one or more mobile devices and a server in accordance with the present teachings.

FIG. 5 is one example of a segment of a frequency of spoken word database in accordance with the present teachings.

FIG. 6 is one example of tables illustrating a segment of an advertisement database with linked observation phrases having associated importance values.

FIG. 7 is a flow diagram illustrating one example of a method for advertising using a frequency of spoken word database in accordance with the present teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of disclosed embodiments. In addition, the description and drawings do not necessarily require the order illustrated. It will be further appreciated that certain actions, functions, and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

In one embodiment herein is provided a method performed by an electronic device or system, such as a server, for advertising using a frequency of spoken word database. The method includes sending a plurality of observation phrases to a plurality of mobile devices. The method further includes receiving, from a subset of the plurality of mobile devices for each observation phrase in a subset of the plurality of observation phrases, at least one utterance statistic that indicates how often utterance of the observation phrase was detected over a time period. The method also includes building a frequency of spoken word database with the subset of the plurality of observation phrases each having associated therewith a set of frequency of utterance values derived from the at least one utterance statistic received for that observation phrase. The frequency of spoken word database is used to determine at least one advertisement and linked observation phrase to send to a first mobile device.

In accordance with a further embodiment is an electronic device or system configured for advertising using a frequency of spoken word database. In one embodiment the electronic device includes a network interface configured to send a plurality of observation phrases to a plurality of mobile devices. The network interface is also configured to receive, from a subset of the plurality of mobile devices for each observation phrase in a subset of the plurality of observation phrases, at least one utterance statistic that indicates how often utterance of the observation phrase was detected over a time period. The electronic device also includes a processor coupled to the network interface and configured to build a frequency of spoken word database comprising the subset of the plurality of observation phrases each having associated therewith a set frequency of utterance values derived from the at least one utterance statistic received for that observation phrase. The processor is also configured to determine, using the frequency of spoken word database, at least one advertisement and linked observation phrase to send to a first mobile device.

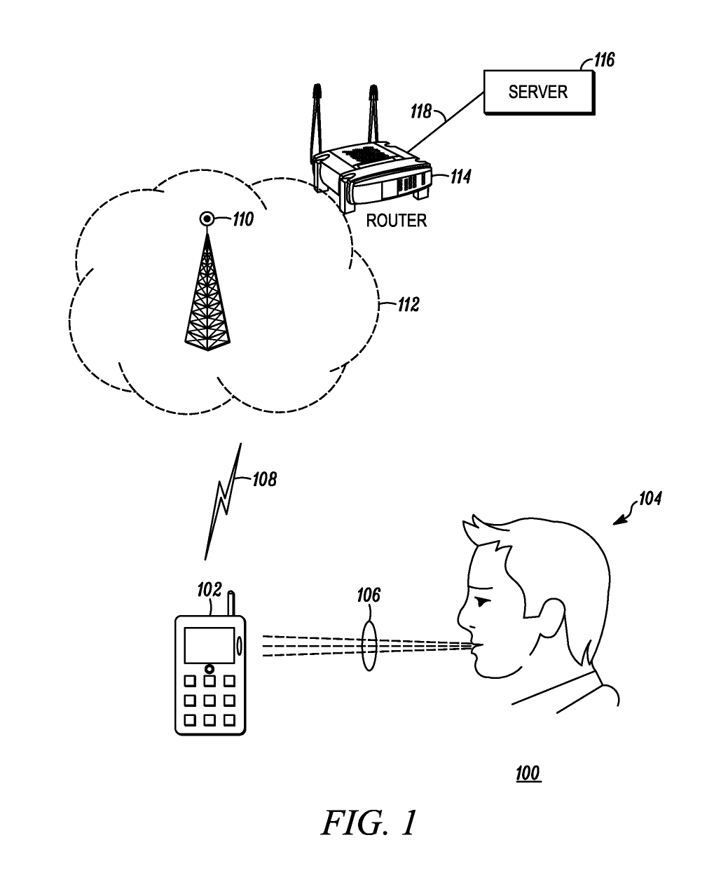

Referring to the drawings, and in particular to FIG. 1, illustrated therein is a schematic diagram of an example environment 100 within which may be implemented methods and devices for advertising using a frequency of spoken word database. In this particular embodiment, a wireless communication device 102, such as a mobile or portable device is configured to be interacted with by a user 104. In one example, the mobile device 102 is configured to detect user utterances 106 such as vocalized information or speech from the user 104. The mobile device 102 is also configured to establish wireless connections or links 108 with, for example, a base station 110 that is part of one or more networks 112, referred to herein as a telecommunications network 112.

The telecommunications network 112 may have one or more routers 114 configured to communicate with a server 116, for instance a server in the Internet, over a wired link 118. In accordance with embodiments of the present teachings, the communication device 102 is configured to monitor the utterances 106 of the user 104 to detect whether an observation phrase, which was provided to the device 102 by the server 116, was spoken. Where utterance of the observation phrase is detected, the mobile device is further configured to determine at least one utterance statistic to send to the server 116 for the observation phrase. The utterance statistic is calculated based on, in one embodiment, how often utterance of the observation phrase was detected in a certain time frame. In another embodiment, the utterance statistic is based on other parameters associated with detecting an observation phrase. The utterance statistics are collected based on other parameters associated with the number of times an observation phrase was detected. The server 116 is configured to use the utterance statistics that it receives from the mobile device 102 and from other mobile devices to build and maintain a frequency of spoken word database, as described in detail herein, in accordance with the present teachings.

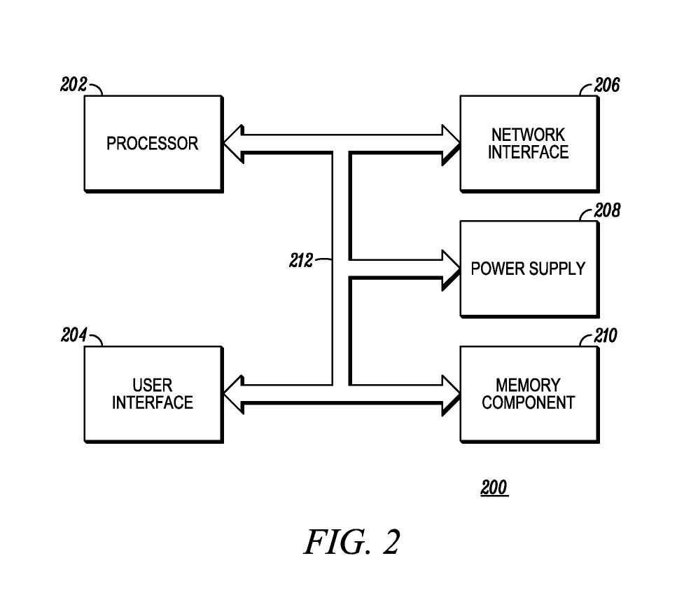

Turning now to FIG. 2, there is provided a block diagram illustrating various internal hardware elements or components 200 of an electronic device also referred to herein generally as a system, such as the server 116 of FIG. 1, which builds and maintains a frequency of spoken word database and an advertisement database in accordance with the present teachings. As shown in FIG. 2, the internal components 200 include one or more processors 202, a user interface 204, a network interface 206, a power supply 208, and a memory component 210, which are configured to operate in accordance with functionality described herein. As further illustrated, the internal components 200 are coupled to one another, and in communication with one another, by way of one or more internal communication links 212, for instance an internal bus. A limited number of device components 202, 204, 206, 208, and 210 are shown at 200 for ease of illustration, but other embodiments may include a lesser or greater number of such components in an electronic device, such as the server 116. Moreover, other elements needed for a commercial embodiment of an electronic device that incorporates the components shown at 200 are omitted from FIG. 2 for clarity in describing the enclosed embodiments.

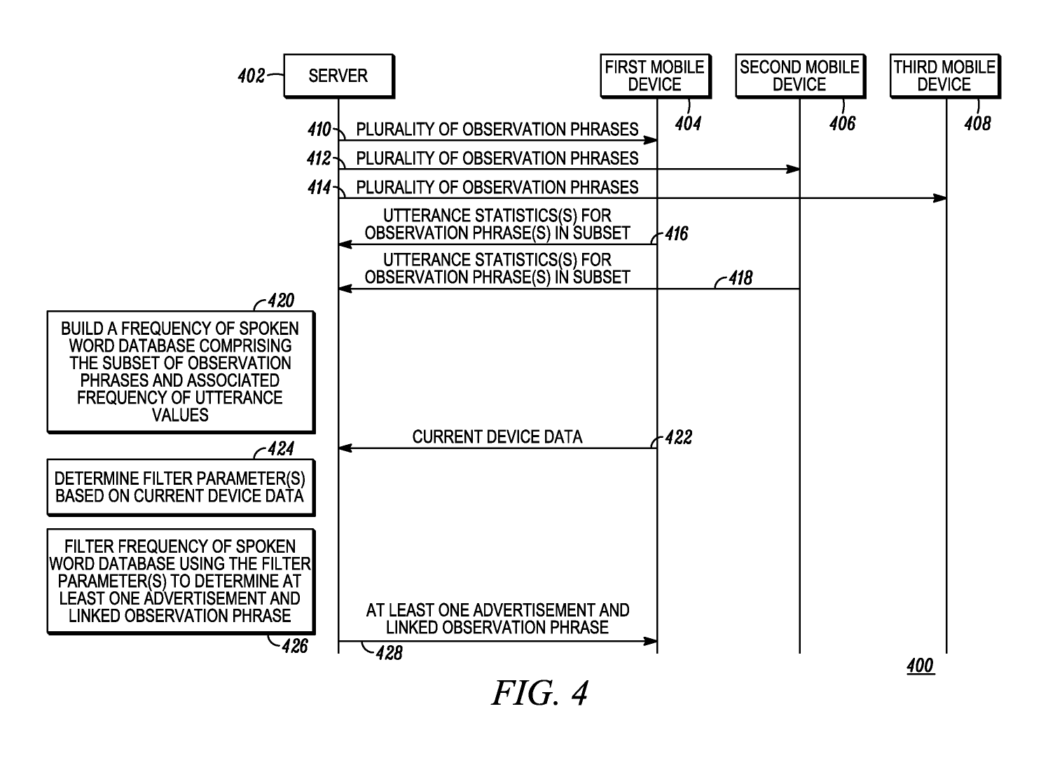

The processor 202 includes arithmetic logic and registers necessary to perform the digital processing required by the server 116 to, for example, perform advertising using a frequency of spoken word database in a manner consistent with the embodiments described herein. For one embodiment, the processor 202 represents a primary microprocessor or central processing unit (CPU) of the server 116 that is configured with functionality in accordance with embodiments of the present disclosure, for instance as described in detail with respect to the FIGS. 4-7. “Adapted,” “operative,” “capable” or “configured,” as used herein, means that the indicated components are implemented using one or more hardware elements, which may or may not be programmed with software and/or firmware as the means for the indicated components to implement their desired functionality. Such functionality is supported by the other hardware shown in FIG. 2, including the device components 204, 206, 208, 210.

The user interface 204 enables a human to interact with the server 116. In one example scenario, the user interface 204 enables a person to configure the components of the server 116, such as the memory 210, with information pertaining to functionality in accordance with the disclosed teachings. Accordingly, in one embodiment, the user interface 204 enables a person to configure memory component 210 with observation phrases, where such phrases will be described further herein. Example user interfaces 204 include, but are not limited to devices such as, keyboards, touchscreens, a mouse, voice recognition systems, joysticks, trackballs, and the like.

The network interface 206 enables the server 116 to communicate with devices, such as the mobile device 102, that are external to the server 116 in either a wired or wireless manner to receive and/or send messages in support of performing the teaching as described herein. The server 116, in one example, communicates in a wireless manner via one or more transceivers (not specifically shown) that are part of the network interface. 206 A wired interface (not specifically shown) of the network interface 206 of the server 116 includes, for example, Ethernet, Token Ring, Fiber Distributed Data Interface, Asynchronous Transfer Mode, X.25 and the like. The power supply 208, such as a battery, provides power to the other internal components 200 to enable their functionality.

The memory component 210 in various embodiments can include one or more of: volatile memory elements, such as random access memory (RAM); or non-volatile memory elements, such as a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), or a Flash memory. In an embodiment, the processor 202 uses the memory component 210 to store and retrieve data. In some embodiments, the memory component 210 is integrated with the processor 210 into a single component such as on an integrated circuit. However, such a single component still usually has distinct portions/sections that perform the different processing and memory functions.

The data that is stored by the memory component 210 includes, but need not be limited to, operating systems, programs (e.g., applications, protocols, and other code), and informational data. Each operating system includes executable code that controls basic functions of the server 116, such as interaction among the various components included among the internal components 200, communication with external devices via the network interface 206, and storage and retrieval of programs and data, to and from the memory component 210. As for programs, each program includes executable code that utilizes an operating system to provide more specific functionality, such as file system service and handling of protected and unprotected data stored in the memory component 210. Such programs include, among other things, programming for enabling the server 116 to perform methods or processes such as described below by reference to FIGS. 4-7. Finally, with respect to informational data, this is non-executable code or information such as observation phrases and other data stored in a frequency of spoken word database and an advertisement database that an operating system or program references and/or manipulates, in one embodiment, for performing functions of the server 116.

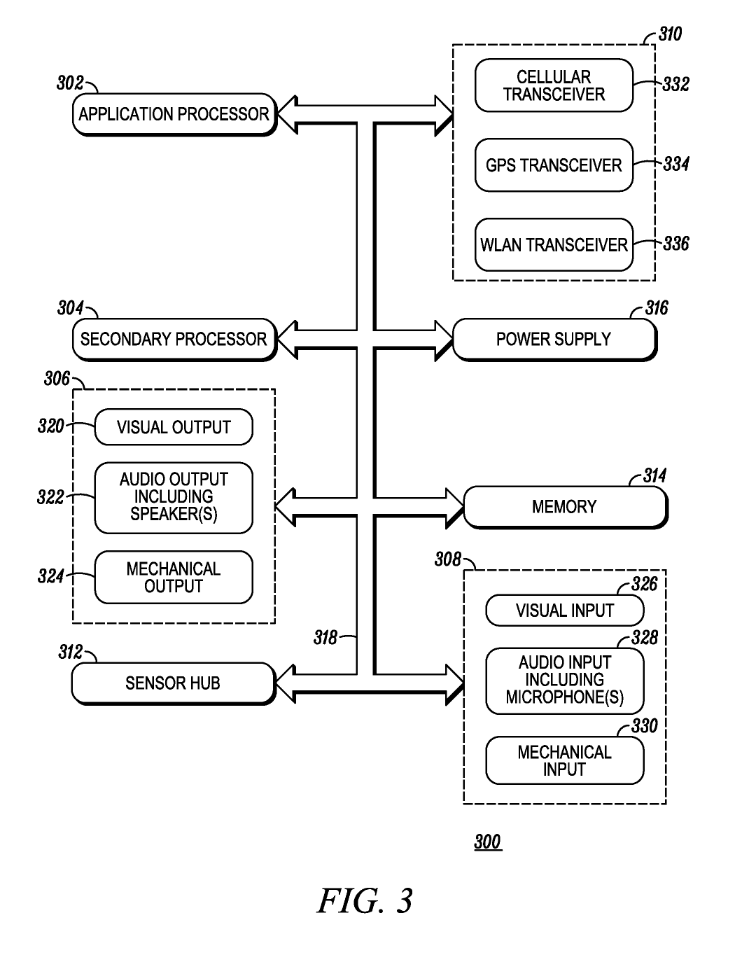

Referring now to FIG. 3, there is provided a block diagram illustrating example internal hardware components 300 of a wireless communication device, such as the mobile device 102 of FIG. 1, in accordance with the present teachings. The mobile device 102 is intended to be representative of a variety of mobile devices including, for example, cellular telephones, personal digital assistants (PDAs), smartphones, or other handheld or portable mobile devices.

As shown in FIG. 3, the internal hardware elements or components 300 include one or more processors including an application processor 302 and a secondary processor 304, output components 306, input components 308, wireless transceivers 310, a sensor hub 312, a memory component 314, and a power supply 316, which are configured to operate in accordance with functionality described herein. As further illustrated, the internal components 300 are coupled to one another, and in communication with one another, by way of one or more internal communication links 318, for instance an internal bus. A limited number of device components 302, 304, 306, 308, 310, 312, and 314 are shown at 300 for ease of illustration, but other embodiments may include a lesser or greater number of such components in a device, such as the device 102. Moreover, other elements needed for a commercial embodiment of a device that incorporates the components shown at 300 are omitted from FIG. 3 for clarity in describing the enclosed embodiments.

We now turn to a brief description of the components within the schematic diagram 300. In general, the processors 302, 304, and/or the sensor hub 312 are configured with functionality for the mobile device 102 to interact with the server 116 to facilitate implementing embodiments of the present disclosure as described in detail below with respect to the remaining FIGS. 4-7. The functionality of the processors 302, 304, and/or the sensor hub 312 is supported by the other hardware shown in FIG. 3, including the device components 306, 308, 310, 312, 314, 316, and 318.

Continuing with the brief description of the device components shown at 300, as included within the device 102, the wireless transceivers 310 include a cellular transceiver 332, a Global Positioning System (GPS) transceiver 334, and a wireless local area network transceiver 336. More particularly, the cellular transceiver 332 conducts cellular communications of data over wireless connections using any suitable wireless technology, such as Third Generation (3G), Fourth Generation (4G), 4G Long Term Evolution (LTE), vis-à-vis cell towers or base stations. In other embodiments, the cellular transceiver 332 utilizes any of a variety of other cellular-based communication technologies such as: analog communication technologies (using Advanced Mobile Phone System—AMPS); digital communication technologies (using Code Division Multiple Access (CDMA), Time Division Multiple Access (TDMA), Global System for Mobile communication (GSM), integrated Digital Enhanced Network (iDEN), General Packet Radio Service (GPRS), Enhanced Data for GSM Evolution (EDGE), etc.); and/or next generation communication technologies (using Universal Mobile Telecommunication System (UMTS), Wideband CDMA (WCDMA), LTE, Institute of Electrical and Electronics Engineers (IEEE) standard 802.16, etc.) or variants thereof.

In one embodiment, the GPS transceiver 334 enables the determination of the geographic location of the communication device 102. The WLAN transceiver 336 conducts wireless communications using various bands and channels of the IEEE 802.11 (a, b, g, or n) and/or Wi-Fi Direct standards or in accordance with other types of wireless access technology such as Worldwide Interoperability for Microwave Access (WiMax).

In the embodiment shown, the output components 306 include: one or more visual output components 320 such as a liquid crystal display and/or light emitting diode indicator; one or more audio output components 322 such as a speaker, alarm, and/or buzzer; and one or more mechanical output components 324 such as a vibrating mechanism. Similarly, the input components 308 include imaging apparatus that in this case includes a visual input 326; one or more acoustic or audio input components 328 such as one or more transducers (e.g., microphones), including for example a microphone array and beamformer arrangement or a microphone of a Bluetooth headset; and one or more mechanical input components 330 such as a touchscreen display, a flip sensor, keyboard, keypad selection button, and/or switch.

The memory component 314 encompasses, in some embodiments, one or more memory elements of any of a variety of forms, for example read-only memory, random access memory, static random access memory, dynamic random access memory, etc. The memory component 314 stores data that includes, but need not be limited to, operating systems, programs (applications), and informational data. The power supply 316, such as a battery, provides power to the other internal components 300 while enabling the mobile device 102 to be portable.

The secondary processor 304, also referred to as an ancillary or adjunct processor, is a separate processor that, in an embodiment, handles peripheral or supportive processes for the application processor 302, which functions as the main processor. In a particular embodiment, the secondary processor 304 supports processes that require less processing power than those performed by the primary processor 302, allowing for continued operation of the device 102 while the primary processor 302 is in a sleep mode. While the primary processor 302 is asleep, the secondary processor 304 monitors, specifically in one embodiment, functionality or activity of the sensor hub 312.

The sensor hub 312 manages the function of one or more sensors of the sensor hub 312. The sensors (which are not specifically shown) include, for example, proximity sensors (e.g., a light detecting sensor, an ultrasound transceiver, or an infrared transceiver), touch sensors, altitude sensors, an accelerometer, a tilt sensor, and a gyroscope, to name a few. In addition, in an embodiment, the sensor hub 312 can be operationally coupled to the processors 302 and 304, and also to the input components 326, 328, 330 enabling the sensor hub 312 to monitor these components in various modes of the mobile device 102, including the sleep mode. A sleep mode, as defined herein, indicates an operational state assumed by a device, such as the mobile device 102, to conserve power over a normal operating state for the device. As the device enters a sleep mode, the device powers down a primary processor such as the application processor 302 but does not power off. Instead, the device retains some minimal functionality using the secondary lower power processor 304. If the power and/or operation of a hardware element, such as a processing element, within the device is reduced or suspended during a sleep mode for the device, then that hardware element is also referred to herein as being in a sleep mode.

Further, the sensor hub 312 can be operationally coupled to the output components 320, 322, 324, enabling the sensor hub 312 to communicate with these elements in various modes, including the sleep mode. Accordingly, in one embodiment, the sensor hub 312 detects sounds, e.g., utterance from the user 104 using one or more of the input components 308 and display output data using one or more of the output components 306 while the mobile device 102 is asleep. In one particular embodiment, the sensor hub 312 detects utterances of words and phrases, including observation phrases while the mobile device 102 is asleep. Further, in one example, the sensor hub 312 is also configured to output graphical images, icons, short videos, broadcast messages, and the like, that are advertisements. The advertisements are displayed/played while the mobile device 102 is asleep, for example.

Turning now to FIG. 4, which is one example of a message sequence chart 400 illustrating communications that occur between mobile devices 404, 406, and 408 and a server 402 in accordance with the present teachings. Using the message sequence diagram 400, the server 402 can build and maintain a frequency of spoken word database to facilitate and feed into an advertising system maintained by the server 402. The frequency of spoken word database is developed to include a plurality of observation phrases that each has associated therewith at least one frequency of utterance value that indicates how often the observation phrase was spoken. As described in detail with respect to the message sequence chart 400, the frequency of utterance values are derived from utterance statistics received from multiple mobile devices, for instance over a period of time. Only three mobile devices are shown for ease of illustration. However, to build a comprehensive frequency of spoken word database, the server 402 sends observation phrases to many more mobile devices, e.g., hundreds or thousands, over the course of weeks or months, in one implementation scenario, to gather utterance statistics to build the frequency of spoken word database.

In one example, the server 402 is configured with multiple observation phrases. An observation phrase, as used herein, is one or more words that a mobile device “listens” for to report statistics back to a server and/or to display a linked advertisement. The server 402 can be configured with the observation phrases by a user through its user interface 204 and/or the server 402 may receive at least some of the observation phrases from advertisers through its network interface 206. Notwithstanding how the server 402 was configured with the observation phrases, the server 402 sends 410, 412, 414 a plurality of the observation phrases to a plurality of mobile devices 404, 406, 408. In one embodiment, the same plurality of observation phrases is sent to all the mobile devices 404, 406, 408. However, the server 402 could send each mobile device a different plurality of observation phrases at different times but in an overlapping manner such that over an extended time each mobile device receives and monitors for the same or many of the same observation phrases.

The mobile devices 404, 406, 408 are configured to detect or listen for utterances of the observation phrases using for example, the audio input component 328. Further, in one example scenario, the mobile devices 404, 406 408 listen for utterances of the observation phrases while the mobile device 404, 406, 408 is in the sleep mode. While detecting observation phrases, each mobile device 404, 406, 408 gathers or compiles utterance statistics associated with each observation phrase, and send, e.g., at 416, 418, the utterance statistics to the server 402. The server 402 is accordingly configured to receive, from a subset (in this case two mobile devices 404 and 406) of the plurality of mobile devices 404, 406, 408 for each observation phrase in a subset of the plurality of observation phrases, at least one utterance statistic. An utterance statistic, as used herein, is a statistic that indicates how often the utterance of a given observation phrase was detected by a mobile device over a time period. In this particular example, the subset of the mobile devices includes the mobile devices 404, 406, which provide at 416 and 418, respectively, utterance statistics for at least some of the observation phrases that these mobile devices receive.

As defined herein, a set includes one or more elements, and a subset of an original set contains as many as all of the elements of the set, or the subset may contain fewer elements than in the original set, but contains at least one element. Thus, a subset of a set of three mobile devices can include all three mobile devices or can contain one or two mobile devices. Moreover, the mobile devices 404 and 406 send utterance statistics for all or some of the plurality of observation phrases received from the server 402. In one example, the server 402 sends 410 the first communication device 404 ten observation phrases and the mobile device 404 sends 416 utterance statistics associated with six of the originally sent ten observation phrases. This may occur because the first mobile device 404 did not detect utterances of four of the original ten observation phrases. The utterance statistics can be calculated or computed using any suitable function. In one embodiment, a mobile device determines how many times it detects utterance of a particular observation phrase and divides that number by an amount of time over which the mobile device listened or monitored for utterance of the observation phrase.

The server 402 builds 420 a frequency of spoken word database comprising the subset of the plurality of observation phrases (for which it received at least one utterance statistic) each having associated therewith a set of one or more frequency of utterance values derived from the at least one utterance statistic received for that observation phrase. The server 402 maintains in its memory component 210 a database of advertisements as well as the frequency of spoken word database. These may be included in one physical memory location or several. In accordance with the present teachings, the frequency of spoken word database is used to determine at least one advertisement, from the advertisement database, and linked observation phrase to send to a mobile device, as explained in detail below by reference to the remaining messages of the message sequence chart 400.

In one example embodiment, the mobile device receives the at least one advertisement and linked observation phrase and displays the advertisement when the mobile device detects an utterance of the observation phrase. In another embodiment, the mobile device detects an utterance of an observation phrase, and then displays the related advertisement at a later time when it is likely the user is looking at the display (such as when the device is removed from a pocket or moved after an extended period of being stationary). The mobile device detects the observation phrase and displays the advertisement, in yet another embodiment, when the mobile device is asleep.

At some point, the server 402 receives 422 current device data from the first mobile device 404. The current device data includes, but is not limited to, information such as device location data, time of day, device characteristic data, user characteristic data, user history of selected advertisements, and/or user search history. The device location data includes a geographic location, which is identified and/or expressed as a general place or area such as a country, town, city, jurisdiction, region, municipality, locality, territory, etc. In another embodiment, the geographic location is identified or expressed as an absolute location or designation using, for example: a specific pairing of latitude and longitude, a Cartesian coordinate grid (e.g., a Spherical coordinate system), an ellipsoid-based system (e.g., World Geodetic System), or similar methods.

The device characteristic data includes, for example, information about the type of device that sent the current device data. For instance, device characteristic data includes whether the device is: a “pay as you go” mobile device; a mid-model, which is a device with a modest number of features; or a full feature, which is a device considered to have all the features of a current top-of-the-line mobile device. Time of day is the time that the current device data was sent. The user history of selected advertisements can include a list of advertisements the user selected on the mobile device 404 in a previous timeframe. For example, the user may have selected an offer associated with a Fizzy Cola advertisement three times in the past week. This selection, for instance, is a statistic associated with user history of the selected advertisement. The user search history includes a list of searches the user performed on the mobile device 404. The user search history, in one example, identifies searches the user performed on a web browser search engine running on the mobile device 404. The user search history may also be stored on the server 402 and retrieved based on a user ID provided, in one example, as part of the device characteristic data.

The server 402 filters the frequency of spoken word database by at least one filter parameter to determine at least one advertisement and linked observation phrase to send to the first mobile device. In one example embodiment, the filter parameters include the time of day, the geographic region, the user characteristic data, and/or the device characteristic. For instance, the server 402 receives 422 the current device data from a mobile device and determine 424, based on the current device data, the at least one filter parameter. The server 402 uses the at least one filter parameter for filtering 426 the frequency of spoken word database to determine at least one advertisement and linked observation phrase to send 428 to the mobile device 404.

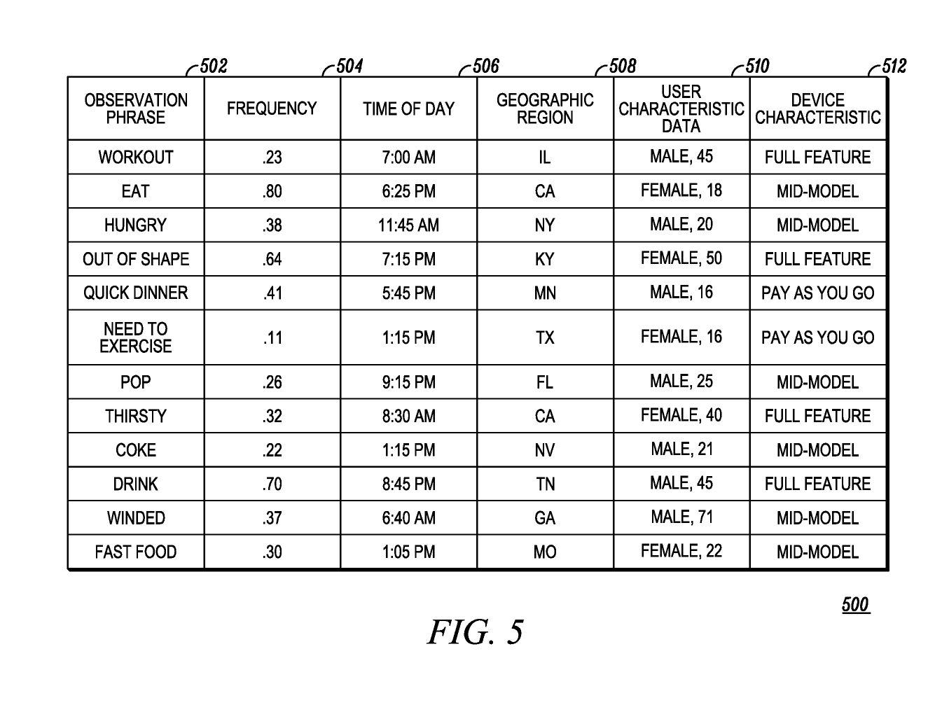

Turning now to FIG. 5, which shows one example of a frequency of spoken word database 500. The database 500 includes multiple observation phrases 502 containing one or more words and, in one example, a number of different types of information 504, 506, 508, 510, and 512, for instance, associated with each observation phrase. In the example shown, the frequency of spoken word database 500 includes information such as, the observation phrases 502, frequency 504, time of day 506, geographic region 508, user characteristic 510, and device characteristic 512. More particularly, an electronic device such as the server 116 or 402, has built the frequency of spoken word database 500 to include the observation phrases “workout,” “eat,” “hungry,” “out of shape,” “quick dinner,” “need to exercise,” “pop,” “thirsty,” “coke,” “drink,” “winded,” and “fast food.”

The observation phrase “workout” is shown as associated or connected with: a frequency of 0.23; a time of day of 7:00 am; a geographic region of IL; user characteristic data of male, 45; and a device characteristic of full feature. The observation phrase “eat” is shown as associated or connected with: a frequency of 0.80; a time of day of 6:25 pm; a geographic region of CA; user characteristic data of female, 18; and a device characteristic of mid-model. The observation phrase “hungry” is shown as associated or connected with: a frequency of 0.38; a time of day of 11:45 am; a geographic region of NY; user characteristic data of male, 20; and a device characteristic of mid-model. The observation phrase “out of shape” is shown as associated or connected with: a frequency of 0.64; a time of day of 7:15 pm; a geographic region of KY; user characteristic data of female, 50; and a device characteristic of full feature. The observation phrase “quick dinner” is shown as associated or connected with: a frequency of 0.41; a time of day of 5:45 pm; a geographic region of MN; user characteristic data of male, 16; and a device characteristic of pay as you go. The observation phrase “need to exercise” is shown as associated or connected with: a frequency of 0.11; a time of day of 1:15 pm; a geographic region of TX; user characteristic data of female, 16; and a device characteristic of pay as you go.

The observation phrase “pop” is shown as associated or connected with: a frequency of 0.26; a time of day of 9:15 pm; a geographic region of FL; user characteristic data of male, 25; and a device characteristic of mid-model. The observation phrase “thirsty” is shown as associated or connected with: a frequency of 0.32; a time of day of 8:30 am; a geographic region of CA; user characteristic data of female, 40; and a device characteristic of full feature. The observation phrase “Coke” is shown as associated or connected with: a frequency of 0.22; a time of day of 1:15 pm; a geographic region of NV; user characteristic data of male, 21; and a device characteristic of mid-model. The observation phrase “drink” is shown as associated or connected with: a frequency of 0.70; a time of day of 8:45 pm; a geographic region of TN; user characteristic data of male, 45; and a device characteristic of full feature. The observation phrase “winded” is shown as associated or connected with: a frequency of 0.37; a time of day of 6:40 am; a geographic region of GA; user characteristic data of male, 71; and a device characteristic of mid-model. The observation phrase “fast food” is shown as associated or connected with: a frequency of 0.30; a time of day of 1:05 pm; a geographic region of MO; user characteristic data of female, 22; and a device characteristic of mid-model.

Referring momentarily back to FIG. 4, in that use case scenario, the subset of observation phrases for which the mobile devices 404 and 406 sent utterance statistics to the server 402 are included in the frequency of spoken word database 500. Each observation phrase 502 may not have associated therewith all of the categories 504, 506, 508, 510, and 512 shown. Moreover, at least one observation phrase may have multiples values or entries within the same information category. For example, a single observation phrase may have different frequency information 504 depending on the time of day.

The frequency category includes frequency of utterance values, which encompass information about how often an observation phrase was detected. In one example, the frequency of utterance value is the number of times an observation phrase is uttered during a time frame. In another example, the frequency of utterance value includes the frequency that a mobile device detects a particular observation phrase in comparison to all other observation phrases. If this were the case, as FIG. 5 illustrates, the observation phrase “need to exercise” constitutes 11% of the all observation phrases detected. In other embodiments, the frequency information represents the percentage of time an observation phrase appears among a category of words. For a particular example, mobile devices detected the phrase “out of shape” 64% of the time among phrases constituting exercise related observation phrases. Similarly, in other embodiments, the frequency of utterance value represents frequency of utterances of an observation phrase as a percentage of overall detection of: the observation phrase detected from users having a predetermined characteristic, for example, the frequency of utterance value represents the frequency that males utter an observation phrase as a percentage of all observation phrases uttered by males; devices having a predetermined characteristic, for example, the frequency of utterance value represents the frequency that full feature mobile devices detect an observation phrase as a percentage of all observation phrases detected by full feature mobile devices; utterances of the observation phrase from a particular geographic region; or utterances of an observation phrase as a percentages of total utterances associated with another type of predetermined criteria.

In one example, the time of day 506 is the time of day that a user uttered a particular observation phrase. The database 500 illustrates that the user uttered the phrase thirsty at 8:30 am. In another example, the time of day 506 is the beginning of a time frame in which users uttered a particular observation phrase. The database 500 includes the frequency that users uttered the observation phrase “workout” during, for example, an hour time frame, which began at 7:00 am. The geographic region 508 is a geographic region in which users uttered observation phrases. In the database 500, the observation phrase “eat” was detected in California. Although, this particular example depicts geographic region on a statewide basis, in other examples, the geographic region is associated with a city, county, township, neighborhood, region of a country, or other type of geographical areas.

The user characteristic 510 includes characteristics about the user that uttered a particular observation phrase. For example, the user that uttered the observation phrase “thirsty” is a 40-year-old female. Although this example shows the user characteristic data of age and sex, in other embodiments other characteristics are included, such as user income, hobbies, organization affiliations, and such. The device characteristic 512 includes information about the mobile device that detected the observation phrase. The different types of devices include, but are not limited to, pay as you go, mid-model, and full feature, which are types of devices previously mentioned in conjunction with devices providing current device data.

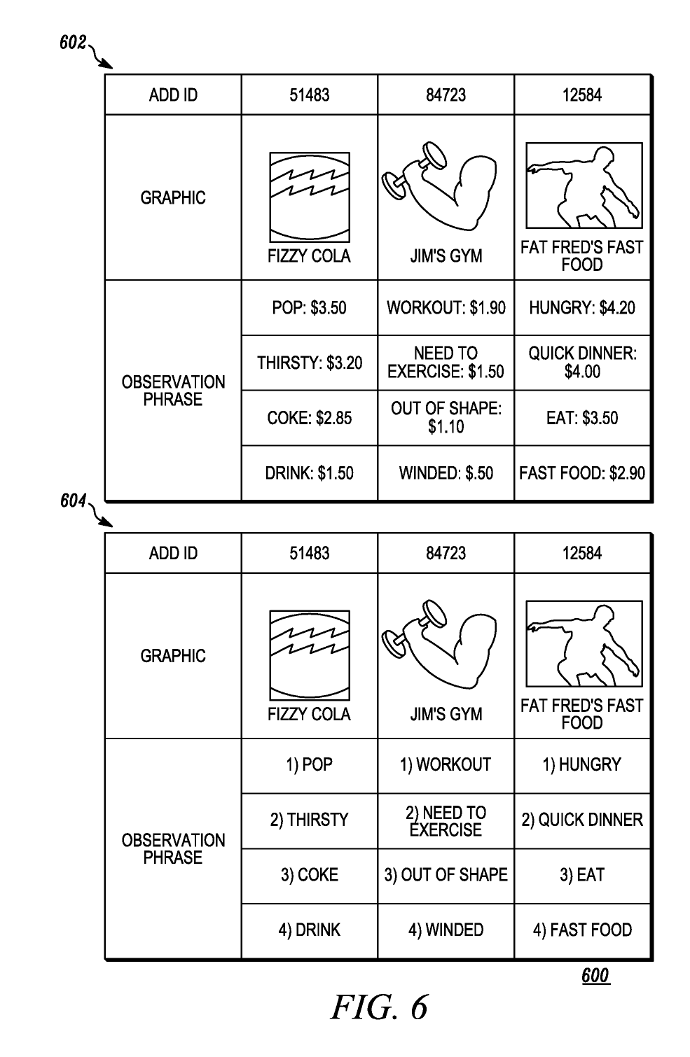

Turning now to FIG. 6, which shows two tables 602 and 604 that each illustrate a manner of organizing an advertisement database having advertisements associated with a plurality of advertisers. As shown in both tables, advertisements for Fizzy Cola, Jim's Gym, and Fat Fred's Fast Food are each associated with or linked to an add ID in a top row of the tables and a graphic in a middle row of the tables. Moreover, each advertisement in the advertisement database has at least one linked observation phrase, illustrated in a third row of the tables, which is used to trigger the display of the advertisement on a mobile device. More particularly, the Fizzy Cola advertisement has an add ID of 51483 and is linked to observation phrases pop, thirst, Coke, and drink. The Jim's Gym advertisement has an add ID of 84723 and is linked to observation phrases workout, need to exercise, out of shape, and winded. The Fat Fred's Fast Food advertisement has an add ID of 12584 and is linked to observation phrases hungry, quick dinner, eat, and fast food.

A difference between the two tables 602 and 604 is the type of importance value that can be used, for instance, to prioritize advertisements to send to a mobile device. An importance value is an indication of importance or priority of the observation phrase to an advertiser with respect to the advertisement to which the observation phrase is linked. For example, in each of the tables 602, 604 the observation phrases “pop,” “thirsty,” “coke,” and “drink” are linked to the Fizzy Cola advertisement. However, the importance value is indicated by dollar amounts in table 602, where in one embodiment the dollar amount is determined based on a monetary bidding. Whereas, the importance value is indicated by a ranked listing in the table 604. The ranked listing of an observation phrase, in one example, depends on how the server 402 ordered observation phrases that the mobile devices sent to the server 402. In one embodiment, the server 402 orders the list based on when the observation phrase was placed in the list. The observation phrases in each of the tables are prioritized in order to determine which advertisement and linked observation phrase(s) are sent to a mobile device.

In one example, the memory component 314 limitations of a mobile device constrain the number of linked observation phrases and advertisements that can be stored on the mobile device. Thus, a priority is established to determine which of a plurality of candidate advertisements and linked observation phrases are sent to the mobile device. In an embodiment, the advertisements linked to the highest priority observation phrases are communicated to the mobile device. The observation phrases illustrated in the tables of FIG. 6 are arranged from the highest to the lowest priority. For example, the highest priority observation phrase linked with the Jim's Gym is “workout”, and the lowest priority observation phrase linked with Jim's Gym is “winded.” If, for example, the server 402 is sending advertisements for Jim's Gym to a mobile device that is configured to store only two observation phrases, the server 402 sends the observation phrases “workout” and “need to exercise” to the mobile device.

As mentioned earlier the two tables 602, 604 differ in that the tables are hierarchically arranged based on different ways of prioritizing the observation phrases. In this example, table 602 is prioritized based on a monetary bidding scheme, and table 604 is prioritized based on a numerical ranking. In one example implementation, the monetary bidding scheme is an online auction where people who represent advertisers submit real-time bids via programmed software. As table 602 illustrates, in regards to Fizzy Cola, because the observation phrase “pop” has a higher associated monetary amount ($3.50) than the observation phrase “thirsty”, “pop” has a higher priority to the advertiser than “thirsty.”

It is possible to establish this monetary based priority in different ways. In one example, a monetary priority is established based on real-time bidding on observation phrases as the server 402 receives current device data. The advertisers adjust their bid based on parameters of the current device data, such as device location, time of day, device characteristic data, user characteristic data, user history of selected advertisements, and/or user search history, and the like. In one example, when the mobile device 404 sends the current device data to the server 402, advertisers bid in real-time to have their advertisement displayed on the mobile device 404 when the mobile device 404 detects an observation phrase that the server 402 links with the advertisement. So, based on table 602, Fizzy Cola bid $3.50 on the observation phrase “pop.” An example competitor, Flat Cola, may have bid $3.00 on the phrase “pop.” Therefore, because the bid of Fizzy Cola was higher, the Fizzy Cola advertisement is displayed when electronic device detects the observation phrase “pop.” In another embodiment, the monetary bidding is not done real-time. The bidding is performed: ranking based on the monetary bidding is established; and the ranking is maintained until another monetary bid occurs. In still other embodiments, the monetary prioritization of the observation phrases is based on other criteria.

The table 604 illustrates another example of hierarchically prioritized observation phrases. In this example, the observation phrases are prioritized based on an assigned numerical ranking. The numerical ranking of each observation phrase can allocated in different ways. In one example embodiment, a service provider allocates the numerical ranking to preferred advertisers. For example, if Fat Fred's Fast Food is a frequent advertiser with the service provider, in one embodiment, the service provider allows Fat Fred to choose the observation phrase ranking that will be linked with Fat Fred's advertisements. In the example illustrated in table 604, Fat Fred chose “hungry” as the top priority observation, “quick dinner” as the second priority, etc. In another embodiment, the numerical ranking order of the observation phrase within a list is established by the server 402. The server 402, in one example, establishes this order based on the order in which the server receives an observation phrase, for instance from an advertiser. In other embodiments, the observation phrase ranking and/or order is allocated based on different criteria.

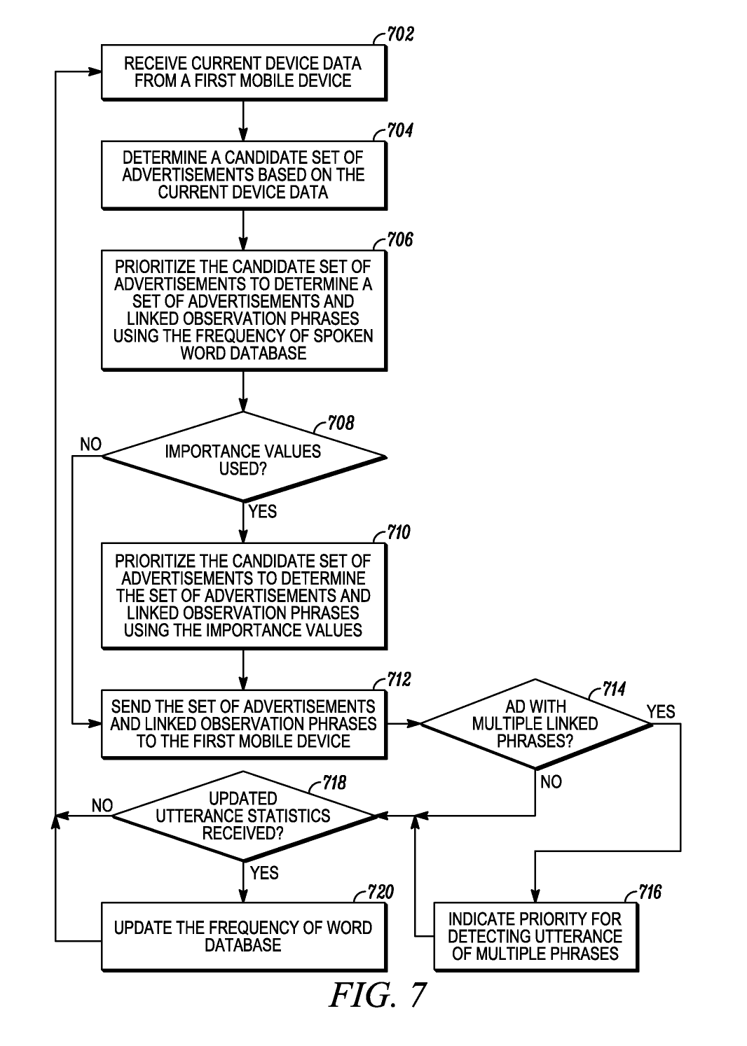

Turning now to FIG. 7, which illustrates one example of a method 700 for advertising using a frequency of spoken word database. In an embodiment, the method 700 is performed by an electronic device or system such as the server 402. As shown, the method 700 includes receiving 702 from a mobile device current device data. In general, the server 402 determines a first set of advertisements that are linked to a first set of observation phrases from the frequency of spoken word database. In one example, the first set of advertisements is determined based on the current device data and based on frequency of utterances values for the first set of linked observation phrases. Further, the server 402 sends 712 the first set of advertisements and linked first set of observation phrases to a mobile device. In one embodiment, each observation phrase, in the linked first set of observation phrases is assigned an importance value, as illustrated for instance by reference to tables 602 and 604 of FIG. 6.

More specifically by reference to method 700, after receiving 702 the current device data, the server 402 determines 704 a candidate set of advertisements based on the current device data. The candidate set of advertisements is a group of advertisements initially selected from among all the advertisements on the server 116. The server 402 further prioritizes 706 the candidate set of advertisements and linked observation phrases using the frequency of spoken word database. This is done, for instance, by filtering, ranking, or prioritizing based on frequency of utterance values for the linked observation phrases. In an embodiment where, at 708, importance values are not used, the set of advertisements and linked observation phrases determined using the frequency of utterance values is sent 712 to the mobile device.

In another embodiment as shown importance values are used 708. Where, at 708, the observation phrases are assigned an importance value, the server 402 determines the first set of advertisements and linked first set of observation phrases to send to the mobile device based on the importance values for the first set of observation phrases. In accordance with this embodiment, the server 402 prioritizes or filters 710 the candidate set of advertisements to determine the first set of advertisements and linked first set of observation phrases based on the frequency of utterance values and the importance values for observation phrases linked to the candidate set of advertisements. In one embodiment, the candidate set of advertisements is prioritized or filtered to determine the first set of advertisements and linked first set of observation phrases using a function that includes the frequency of utterance value multiplied by (*) the importance value.

In one example embodiment, the Fizzy Cola advertisement receives a prioritization value of: (0.26*$3.50)+(0.32*$3.20)+(0.22*$2.85)+(0.70*$1.50)=3.61. The Jim's Gym advertisement receives a prioritization value of: (0.23*$1.90)+(0.11*$1.50)+(0.64*$1.10)+(0.37*$0.50)=1.49. The Fat Fred's Fast Food advertisement receives a prioritization value: (0.38*$4.20)+(0.41*$4.00)+(0.80*$3.50)+(0.30*$2.90)=6.91. Accordingly, where the mobile device has limited storage space, such as within a sensor hub 312, the server 402 may determine 710 the set of advertisements that it sends 712 to the mobile device to include the two advertisements, in this case for Fizzy Cola and Fat Fred's Fast Food, which have the highest prioritization values. The server 402 can also send 712 all of the observation phrases linked to each of these two advertisements or only some of those observation phrases depending, for instance, on the storage capacity of the mobile device.

In some cases, such as the example scenario described above, the server 402 links multiple observation phrases with one or more advertisements. Where, at 714, an advertisement is linked with multiple observation phrases, the server 402 indicates 716 to the mobile device a priority for detecting utterance of the multiple observation phrases in order to display the first advertisement. In one embodiment, the priority for detecting the utterance of multiple observation phrases is based on the time of day and/or a geographic region. For example, if the current device data indicates that the time of day is around lunchtime, the word “lunch” receives, in one example, a higher priority than, for example, the word “dinner.” If the current device data originated from a region of the country where “pop” is said more frequently than “soda,” the server 402 prioritizes the observation phrases such that the word “pop” has a higher priority than the word “soda.” In other examples, the priority for detecting the utterance of multiple observation phrases is determined based on previous user searches. For example, if the user previously performed an Internet search for “lunch places,” the observation phrase “lunch” is given a higher priority over another word, such as, “hungry.”

In one embodiment, mobile devices are configured to continue to listen for observation phrases and update utterance statistics associated with the observation phrases. As a mobile device updates utterance statistics associated with an observation phrase, in one example, the mobile device is further configured to send the updated utterance statistics to the server 402 either in a separate message or along with current device data. Accordingly, the server 402 receives 718, from the mobile device, at least one updated utterance statistic for a first observation phrase in the linked first set of observation phrases. The server 402 then updates 720, using the at least one updated utterance statistic, the set of frequency utterance values for the first observation phrase in the frequency of spoken word database. In either case, the method returns to 702 when the server 402 received current device data from the same or a different mobile device.

In still other embodiments, the server 402 intermittently sends new observation phrases to mobile devices, and the mobile devices are configured to send updated utterance statistics for the observation phrases. In one embodiment, the updated utterance statistics for the new observation phrases are part of current device data. In other embodiments, the updated utterance statistics are sent in a separate message.

Returning now to a description of a mobile device, such as mobile device 404 of FIG. 4, and the operations of such a mobile device in accordance with the present teachings. As previously described, the mobile device 404 is configured to operate in a sleep mode in which the mobile device powers down at least its main processor, but does not power off. Instead, the mobile device uses the low power secondary processor 304 as well as various other components of the communication device 404 to maintain some limited functionality. In one example, the mobile device 404 maintains power and functionality of the secondary processor 304, the sensor hub 312, one or more of the output components 306 and one or more of the input components 308. In other embodiments, the mobile device 404 maintains power to fewer or more components.

Because various components of the mobile device 404 are operational when the mobile device 404 is in the sleep mode, the mobile device 404 can perform some functions. For example, while the mobile device 404 is in the sleep mode: the visual output 320 can display images; the audio input 328 can detect utterances; the sensor hub 312 can detect sensed motion and orientation of the mobile device 404; and the secondary processor 304 can store and process data. There are, however, functionalities that the mobile device 404 cannot do while in the sleep mode. For example, in one embodiment, the wireless transceivers 310 are powered down when the mobile device 404 is in the sleep mode, thus the mobile device 404 cannot communicate wirelessly with external devices, such as the server 402.

When the mobile device 404 is awake or in a normal mode of operation, the mobile device 404 receives 410 the plurality of observation phrases. These observation phrases are stored, for example, in memory 314, or in RAM of the secondary processor 304 or the sensor hub 312. When the mobile device 404 enters the sleep mode, in one embodiment, the sensor hub 312 retrieves the observation phrases and activate the audio inputs 328. While in the sleep mode, the audio inputs 328 detect utterances, and communicate those detected utterances to the sensor hub 312. The sensor hub 312 determines whether any of the detected utterances are an observation phrase. When a detected utterance is an observation phrase, the sensor hub 312 computes utterance statistics associated with the detected observation phrase. In one embodiment, the sensor hub 312 computes the utterance statistics as each observation phrase is detected. In another embodiment, the sensor hub 312 computes utterance statistics at certain time intervals. Although, the sensor hub 312 is described as determining whether an observation phrase is uttered and computing utterance statistics, in other embodiments, the secondary processor 304 or another processor of the mobile device 404 performs these operations.

The mobile device 404 continues to detect utterances and compute utterance statistics while in the sleep mode. When the mobile device awakens, the primary processor 302 is now powered-up and in communication with the other components of the mobile device 404. Further, the mobile device 404 can now communicate with external devices, such as the server 116. When the mobile device 104 is awake, the sensor hub 312 and/or the secondary processor 304 communicates the collected utterance statistics to the application processor 302. The application processor 302 sends 416 utterance statistics associated with the subset of the plurality of observation phrases to the server 402 to use in building the frequency of spoken word database.

When the mobile device 404 is awake, it can send 422 current device data to the server 402. The mobile device 404, in one embodiment, sends the current device data at predetermined time intervals. For example, the mobile device 402 sends current device data every 10 minutes when awake. In another, embodiment, the mobile device 404 sends current device data when the mobile device 404 changes locations, for instance, when it moves from one city to another, or from one base station to another, etc. As previously described, the current device data includes information such as device location data, time of day, device characteristic data, user characteristic data, user history of selected advertisements and/or user search history.

When the mobile device 404 enters a sleep mode, the sensor hub 312 activates the audio inputs 328 to detect utterances. If the sensor hub 312 detects utterance of an observation phrase that is linked with at least one advertisement, the sensor hub 304 causes the linked at least one advertisement to be displayed on the visual output 320 while the communication device 404 is in sleep mode. In one embodiment, the advertisement is displayed immediately or substantially immediately upon detecting the uttered observation phrase. In another embodiment, displaying the linked advertisement is delayed until the sensor hub 312 determines that the mobile device 404 is oriented in a manner that enables a user to see the advertisement. For example, the sensor hub 312 waits until the mobile device 404 is oriented face-up to prompt the display of the advertisement. Although, the sensor hub 312 is described as receiving and causing the displaying of the at least one advertisement, in other embodiments, another processor, such as the secondary processor 304 performs this functionality.

In still another embodiment, when the server 402 communicates the at least one advertisement and linked observation phrase, the server 402 also communicates additional observation phrases for which the mobile device 404 collects utterance statistics while in the sleep mode. For each observation phrase it receives, whether or not linked to an advertisement, the mobile device 404 detects utterances of observation phrases and determines utterance statistics associated with those observation phrases.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., including a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method performed by an electronic device for advertising using a frequency of spoken word database, the method comprising:
sending a plurality of observation phrases to a plurality of mobile devices;
receiving, from a subset of the plurality of mobile devices for each observation phrase in a subset of the plurality of observation phrases, at least one utterance statistic that indicates how often utterance of the observation phrase was detected over a time period;
building a frequency of spoken word database comprising the subset of the plurality of observation phrases each having associated therewith a set of frequency of utterance values derived from the at least one utterance statistic received for that observation phrase, wherein the frequency of spoken word database is used to determine at least one advertisement and linked observation phrase to send to a first mobile device.

2. The method of claim 1 further comprising filtering the frequency of spoken word database by at least one filter parameter to determine the at least one advertisement and linked observation phrase to send to the first mobile device.

3. The method of claim 2, wherein the at least one filter parameter comprises at least one of:
time of day;
geographic region;
user characteristic data;
device characteristic data.

4. The method of claim 2 further comprising:
receiving current device data from the first mobile device;
determining, based on the current device data, the at least one filter parameter for filtering the frequency of spoken word database to determine the at least one advertisement and linked observation phrase to send to the first mobile device.

5. The method of claim 1 further comprising:
receiving from the first mobile device current device data;
determining a first set of advertisements that are linked to a first set of observation phrases from the frequency of spoken word database based on the current device data and based on the frequency of utterance values for the first set of observation phrases;
sending the first set of advertisements and linked first set of observation phrases to the first mobile device.

6. The method of claim 5, wherein each observation phrase in the linked first set of observation phrases is assigned an importance value.

7. The method of claim 6, wherein the first set of advertisements and linked first set of observation phrases is further determined based on the importance values for the first set of observation phrases.

8. The method of claim 7 further comprising:
determining a candidate set of advertisements based on the current device data;
prioritizing the candidate set of advertisements to determine the first set of advertisements and linked first set of observation phrases based on the frequency of utterance values and importance values for the first set of observation phrases.

9. The method of claim 8, wherein the candidate set of advertisements is prioritized to determine the first set of advertisements and linked first set of observation phrases using a function comprising frequency of utterance value*importance value.

10. The method of claim 6, wherein the importance value is assigned to each observation phrase in the linked first set of observation phrases based on at least one of:
order of the observation phrase within a list;
numerical ranking of the observation phrase;
monetary bidding of the observation phrase.

11. The method of claim 5, wherein the current device data comprises at least one of:
device location data;
time of day;
device characteristic data;
user characteristic data;
user history of selected advertisements;
user search history.

12. The method of claim 5 further comprising:
receiving, from the first mobile device, at least one updated utterance statistic for a first observation phrase in the linked first set of observation phrases;
updating, using the at least one updated utterance statistic, the set of frequency of utterance values for the first observation phrase in the frequency of spoken word database.

13. The method of claim 5, wherein a first advertisement in the first set of advertisements is linked to multiple observation phrases in the linked first set of observation phrases, the method further comprising indicating to the first mobile device a priority for detecting utterance of the multiple observation phrases in order to display the first advertisement.

14. The method of claim 13, wherein the priority for detecting the utterance of the multiple observation phrases is based on at least one of:
time of day;
geographic region.

15. A system configured for advertising using a frequency of spoken word database, the system comprising:
a network interface configured to:
send a plurality of observation phrases to a plurality of mobile devices; and
receive, from a subset of the plurality of mobile devices for each observation phrase in a subset of the plurality of observation phrases, at least one utterance statistic that indicates how often utterance of the observation phrase was detected over a time period;
a processor coupled to the network interface and configured to:
build a frequency of spoken word database comprising the subset of the plurality of observation phrases each having associated therewith a set of frequency of utterance values derived from the at least one utterance statistic received for that observation phrase; and
determine, using the frequency of spoken word database, at least one advertisement and linked observation phrase to send to a first mobile device.

16. The system of claim 15, wherein:
the network interface is further configured to receive from the first mobile device current device data;
the processor is further configured to determine a first set of advertisements that are linked to a first set of observation phrases from the frequency of spoken word database based on the current device data and based on the frequency of utterance values for the first set of observation phrases;
the network interface is further configured to send the first set of advertisements and linked first set of observation phrases to the first mobile device.

17. The system of claim 16, wherein each observation phrase in the linked first set of observation phrases is assigned an importance value, wherein the processor is further configured to:
determine a candidate set of advertisements based on the current device data;
prioritize the candidate set of advertisements to determine the first set of advertisements and linked first set of observation phrases based on the frequency of utterance values and importance values for the first set of observation phrases.

18. The system of claim 17, wherein the processor is further configured to prioritize the set of advertisements to determine the first set of advertisements and linked first set of observation phrases using a function comprising frequency of utterance value*importance value.

19. The system of claim 17 further comprising a memory component coupled to the processor, wherein the memory component has stored thereon:
the frequency of word database; and
an advertisement database that contains a plurality of advertisements each associated with at least one observation phrase that is assigned an importance value based on at least one of order of the observation phrase within a list, numerical ranking of the observation phrase, or monetary bidding of the observation phrase, wherein the frequency of spoken word database and the advertisement database are used to determine and prioritize the candidate set of advertisements.

20. The system of claim 16 wherein:
the network interface is further configured to receive, from the first mobile device, at least one updated utterance statistic for a first observation phrase in the linked first set of observation phrases; and
the processor is further configured to update, using the at least one updated utterance statistic, the set of frequency of utterance values for the first observation phrase in the frequency of spoken word database.
